(19) United States
(12) Patent Application Publication
(10) Pub. No.: US 2005/0007984 A1
(43) Pub. Date: Jan. 13, 2005

(54) Method and architecture for accessing an internet protocol multimedia subsystem (IMS) over a wireless local area network (WLAN)

(75) Inventors: Kamel M. Shaheen, King of Prussia, PA (US); Prabhakar R. Chitrapu, Blue Bell, PA (US); Brian Gregory Kiernan, Downingtown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/836,037

(22) Filed: Apr. 30, 2004

Related U.S. Application Data
(60) Provisional application No. 60/467,479, filed on May 2, 2003.

(51) Int. Cl. H04J 1/16; H04J 3/14; H04L 12/28; H04L 12/56

(52) U.S. Cl. 370/338; 370/349; 370/401

(57) ABSTRACT

A method and architecture for accessing an IMS over WLANs/WWANs generally, and more particularly over WLANs/WWANs viewed in light of existing related standards is disclosed. More specifically, the invention provides new interfaces enabling IMS access over WLANs/WWANs, and an exemplary method and architecture for such an interface.

### CROSS REFERENCE TO RELATED APPLICATION(S)

This application claims priority from U.S. Provisional Application No. 60/467,479 and filing date of May 2, 2003, which is incorporated by reference as if fully set forth herein.

### FIELD OF INVENTION

The present invention generally relates to internet multimedia subsystems, and more particularly to a method and architecture for accessing internet protocol multimedia subsystems (IMSs) in a wireless local area network.

### BACKGROUND

The architecture for accessing an IMS in regular networks is very popular and is fairly well known in the art. Accessing an IMS in WLANs, however, is a different matter because certain modifications to the architecture of known WLANs are required. Such modifications have neither been addressed in known architecture, nor in standards that regulate and guide the use of an IMS in WLANs. Therefore, there is a need for a suitable architecture and method for accessing an IMS in WLANs as well as WWANs.

The following list of acronyms used in this specification assists in a better understanding of the invention:

| | |
|---|---|
| 3GPP | third generation partnership project |
| AAA | authentication, authorization, accounting |
| BG | border gateway |
| CCF | call control function |
| C-GW | control gateway |
| CSCF | call state control function |
| GGSN | gateway GPRS support node |
| GMSC | gateway MSC |
| GPRS | general packet radio system |
| HLR | home location register |
| HSS | home subscriber service |
| IMS | internet protocol multimedia subsystem |
| IM | internet protocol multimedia |
| IP | internet protocol |
| I-WLAN | interworked WLAN |
| IWMSC | interworking MSC for SMS |
| MGCF | media gateway control function |
| MGW | media gateway |
| MT | mobile terminal |
| OCS | on line charging system |
| PDG | packet data gateway |
| PDN | packet data network |
| PS | packet switched |
| RP-DA | relay sublayer protocol-destination address |
| R-SGW | roaming SGW |
| S-CSCF | serving call state control function |
| SGSN | serving GPRS support node |
| SGW | signaling gateway |
| SIP | session initiation protocol |
| SMS | short messaging service |
| SNCI | serving network contact information |
| TE | terminal equipment |
| TPDU | transfer protocol data unit |
| T-SGW | transport SGW |
| UE | user equipment |
| UMTS | universal mobile telecommunication system |
| UTRAN | UMTS terrestrial radio access network |
| VLR | visitor location register |
| WLAN | wireless local area network |
| WWAN | wireless wide area network |

### SUMMARY

The present invention provides a method and architecture for accessing an IMS over WLANs/WWANs generally, and more particularly over WLANs/WWANs viewed in light of existing related standards. More specifically, the invention provides new interfaces enabling IMS access over WLANs/WWANs, and an exemplary method and architecture for such an interface.

### BRIEF DESCRIPTION OF THE DRAWING(S)

A more detailed understanding of the invention may be had from the following description of preferred embodiments, given by way of example and to be understood in conjunction with the accompanying drawings wherein like elements are designated by like numerals and wherein:

FIG. 1 is a schematic diagram showing a conventional architecture having a direct connection between the call state control function (CSCF) and gateway GPRS support mode GGSN via a Gi interface;

FIG. 2 is a schematic diagram showing an interworking WLAN and 3GPP network;

FIG. 3 is a schematic diagram showing a connection point Wi between the IMS subsystem (i.e. CSCF) and the PDG;

FIG. 4 is a flow diagram showing a session initiation protocol (SIP) registration over an interworked-WLAN (I-WLAN), where the user is not registered;

FIG. 5 is a flow diagram showing termination of IMS based services over a WLAN; and,

FIG. 6 is a schematic diagram showing an interface between a media gateway (MGW) and the PDG.

### DETAILED DESCRIPTION OF THE PREFERRED EMBODIMENT(S)

The present invention will be described with reference to the drawing figures wherein like numerals represent like elements throughout.

Hereafter, a user equipment (UE) includes but is not limited to a wireless transmit/receive unit (WTRU), mobile station, fixed or mobile subscriber unit, pager, or any other type of device capable of operating in a wireless environment. When referred to hereafter, a base station includes but is not limited to a Node-B, site controller, access point, or any other interfacing device in a wireless environment.

The present invention is directed to a method and architecture for accessing IMS services over a WLAN. The details of a connection point and an interface between the IMS subsystem (CSCF) and the PDG on the one hand, and the media gateway (MGW) and the PDG on the other are described. A methodology is set forth herein for accessing IMS to be incorporated into existing standard TS 23.234. More particularly, reference may be had to section 7.8 of the existing standard, directed to procedures for IMS access. The description that follows is generally directed to an architecture which is applicable to existing standards including 802.11 in a UMTS or CDMA 2000 setting, for example. However, the broad concept of the invention is applicable without limitation to other transmission systems as well.

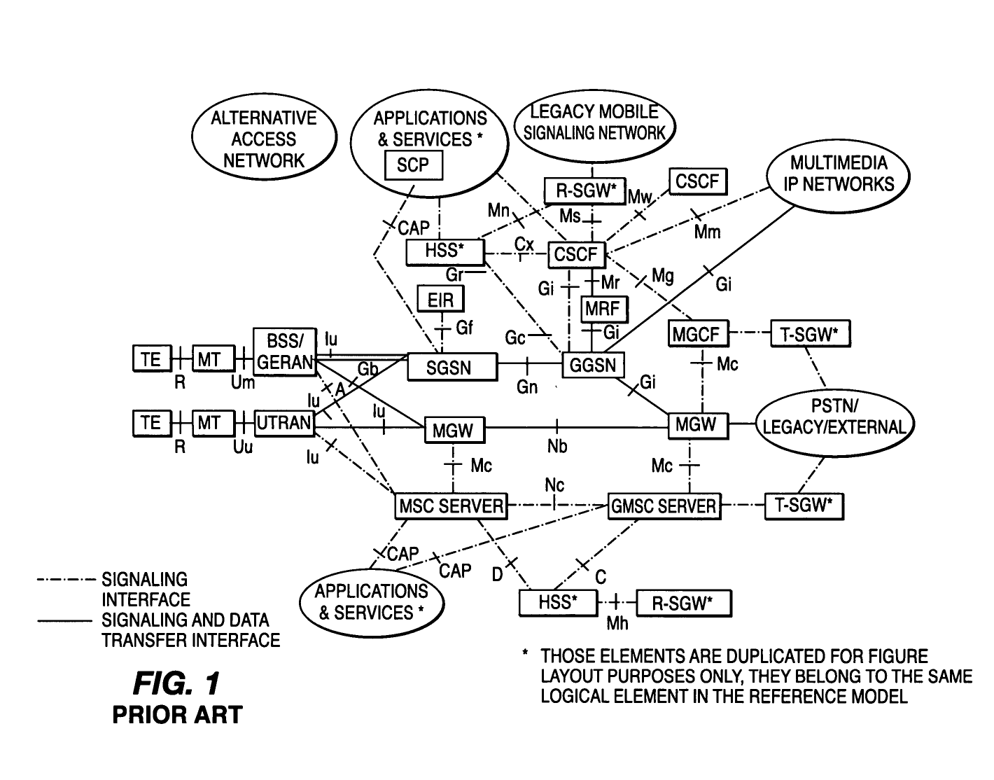

Making reference to FIG. 1, there is shown a conventional architecture which is incorporated into the standard TS 23.234 to enable accessing IMS over a WLAN. The existing reference architecture indicates that direct connection between the CSCF and GGSN via a Gi interface may be necessary. This connection is used to route originated/terminated SIP messages between devices operating in packet switched (PS) domains and the IMS sub-system (i.e., CSCF).

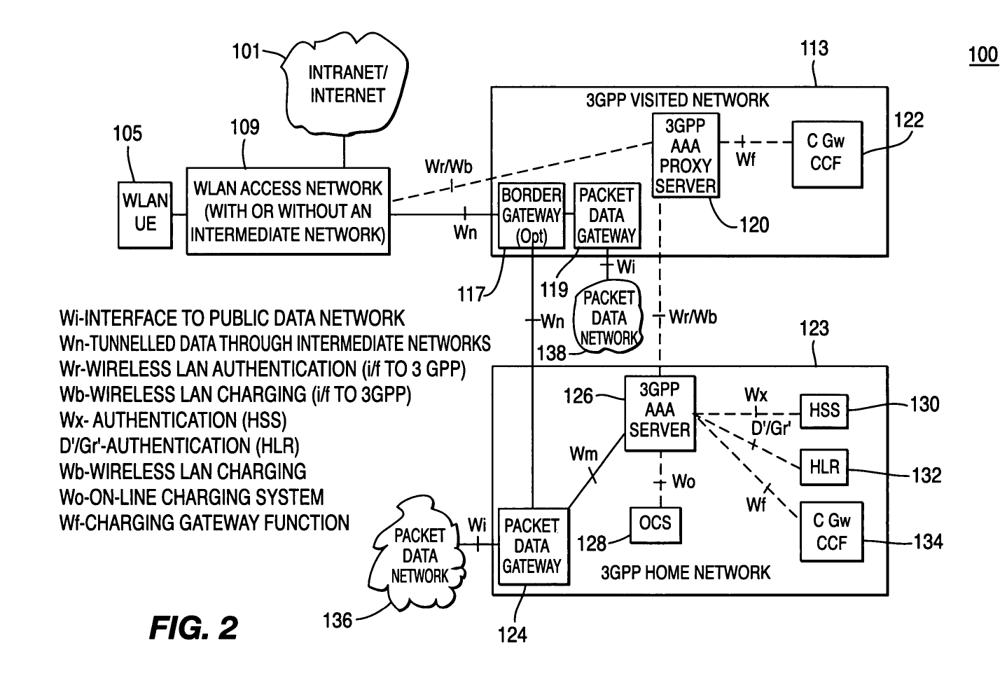

In order to access IMS services over an interworked WLAN (I-WLAN) using a WLAN-UMTS network architecture model as shown in FIG. 2, however, a direct connection is provided between the newly added PDG node and the IMS sub-system (CSCF). This reference point functions in a manner which is similar to other reference points.

More specifically, FIG. 2 is a hardware block diagram showing WLAN-3GPP interworking architecture 100 respectively comprising home and visiting 3GPP networks 123 and 113 utilizing an optional WLAN border gateway (BG). A WLAN user equipment (UE) 105 is coupled to a WLAN access network 109. WLAN access network 109 typically includes one or more intermediate networks. WLAN access network 109 is coupled to the Internet and/or an Intranet, denoted as Intranet/Internet 101.

WLAN access network 109 accesses a 3GPP visited network 113 by way of a WLAN BG 117, and/or optionally via a 3GPP AAA proxy server 120. Communications between WLAN access network 109 and WLAN access gateway 117 is by way of a Wn interface, denoting the tunneling of data through intermediate networks. The link between WLAN access network 109 and optional 3GPP AAA proxy server 120 is by way of a Wr/Wb interface, wherein Wr signifies wireless LAN authentication (information flow to 3GPP), and Wb refers to wireless LAN charging functions. WLAN BG 117 is also coupled to a PDG 119 which, in turn, accesses a packet data network (PDN) 138 over a Wi interface, denoting access to a PDN 138. 3GPP AAA proxy server 120 is coupled to a control gateway-call control function (C-Gw CCF) 122, over a Wf interface, denoting a charging gateway function.

A second PDG 124 is linked to WLAN BG 117 of 3GPP visited network 113 over a Wn interface which, as described above, signifies the tunneling of data through intermediate networks. PDG 124 is linked to a PDN 136 over the above-described Wi interface. PDN 136 may be the same network as PDN 138. PDG 124 is linked to a 3GPP AAA proxy server 126 over a Wm interface. 3GPP AAA proxy server 126 is linked to 3GPP AAA proxy server 120 of 3GPP visited network 113 over a Wr/Wb interface, described above. 3GPP AAA proxy server 126 is also linked to online charging system (OCS) 128, HSS 130, HLR 132, and C-Gw CCF 134. The link between OCS 128 and 3GPP AAA proxy server 126 is a Wo interface which implements online charging, whereas the link between HLR 132 and 3GPP AAA proxy server 126 uses a D′/Gr′ interface which provides authentication of the UE 105, and the link between HSS 130 and 3GPP AAA proxy server 126 utilizes a Wx interface for implementing authentication procedures.

The PDG is a node by which PDNs are connected to a 3GPP interworking WLAN. The location of the PDG is different for each specific service accessed WLAN. For some WLAN connections, no PDG is used. For some accessed services the PDG is in the home network and for some accessed services the PDG used is located in one of the visited networks.

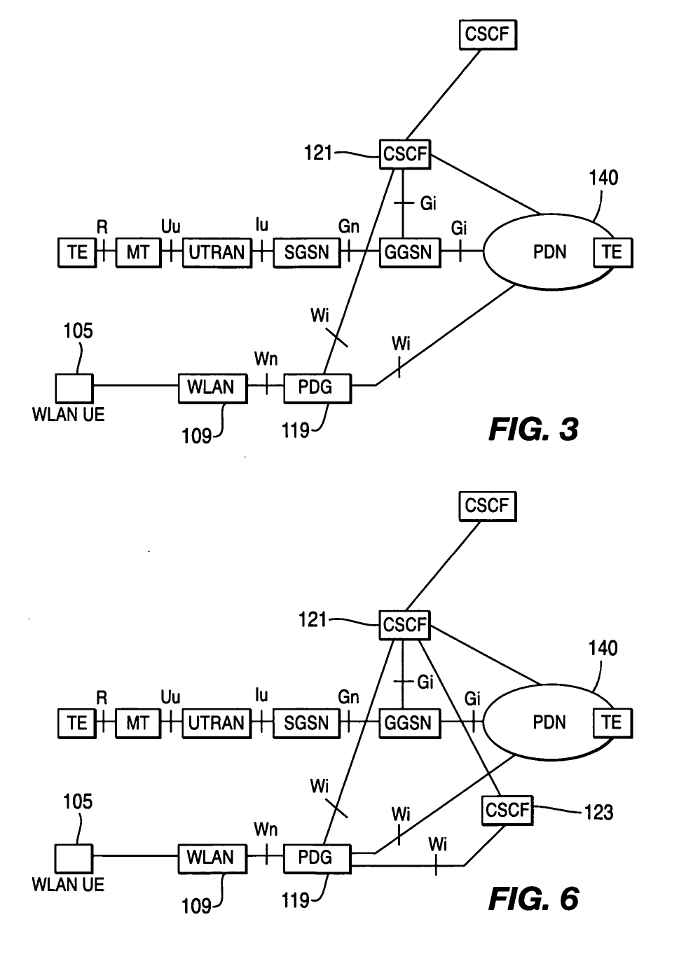

The PDG contains routing information for WLAN-3GPP connected users; routes the packet data received from/sent to the PDN 140, shown in FIGS. 3 and 6, to/from the WLAN-3GPP connected user; performs address translation and mapping; performs encapsulation; and generates charging information related to user data traffic for offline and online charging purposes.

When receiving a short message Transfer Protocol Data Unit (TPDU) from the SMS-gateway MSC (GMSC) (i.e., the CSCF 121 shown in FIG. 3), the PDG 119 is responsible for reception of the short message TPDU.

If errors are detected by PDG 119, the PDG 119 returns the appropriate error information to the SMS-GMSC (i.e., the CSCF 121 shown in FIG. 3) in a failure report. If no errors are detected by PDG 119, the PDG 119 encapsulates and transfers the short message to UE 105 through WLAN 109.

When receiving a confirmation that the message is received by UE 105, PDG 119 relays the delivery confirmation to the SMS-GMSC (CSCF) (i.e., CSCF 121 shown in FIG. 3) in a delivery report.

When receiving a failure report of the short message transfer to the UE 105 PDG 119 returns the appropriate error information to the SMS-GMSC 121 (shown in FIG. 3) in a failure report. When receiving a short message TPDU from the UE 105, the PDG 119 is responsible for reception of the short message TPDU and inspection of the relay sub-layer protocol-destination address (RP-DA) parameter.

If the parameters are not correct, the PDG 119 returns the appropriate error information to the UE 105 in a failure report.

If no parameter errors are found, the PDG 119 transfers the short message TPDU to the SMS-GMSC (i.e., CSCF 121 shown in FIG. 3).

When receiving the report of a short message from a short message service-interworking message service center (SMS-IWMCS), not shown for simplicity, the PDG relays the report to the UE 105.

The new reference point Wi is an interface between the IMS-Subsystem (CSCF) 121 and the PDG 119, as shown in FIG. 3.

The Wi reference point is similar to the Gi reference point provided by the PS domain. Interworking with packet data networks is provided via the Wi reference point based on IP. Services offered by mobile terminals via reference point Wi are globally addressable through the operators' public addressing scheme or through the use of a private addressing scheme. When a 3GPP network, for example, is provided for an IP multi media (IM)-core network (CN), i.e., IM-CN subsystem, the reference point Wi provides a policy control interface.

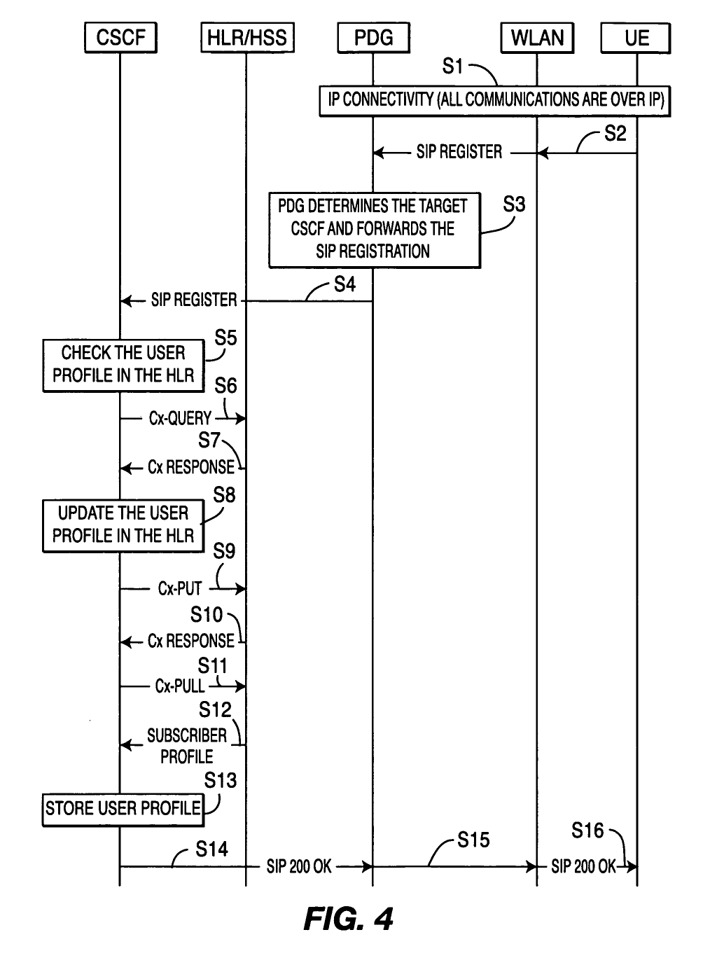

FIG. 4 shows the SIP registration procedure over I-WLAN, when the user is not registered. The application level registration is initiated after access registration is performed and after IP connectivity for the signaling has been attained from the access network. The procedure is explained below.

After the UE has obtained IP connectivity through the WLAN network, at step S1, the UE performs the IM registration. The UE, at step S2, sends the SIP registration information flow to the PDG. The PDG, at step S3, examines the registration message to determine the target CSCF and forwards the registration message to the target CSCF, at step S4.

Upon receipt of the registration information flow, the CSCF, at step S5, checks the user profile in the HLR/HSS and, at step S6, sends Cx-Query information to the HSS (for subscriber identity, home domain name). The HSS determines if the user is already registered and, at step S7, a Cx-Query Response (Resp) is sent from the HLR/HSS to the CSCF. If, at step S6, the HSS determines that the Cx-Query is not successful, the Cx-Query Resp rejects the registration attempt.

At this stage, it is assumed that the authentication of the user has been completed, although it may have been determined at an earlier point in the information flow.

The CSCF (i.e., serving CSCF (S-CSCF)), at step S8, updates the user profile and sends a Cx-Put message (subscriber identity, S-CSCF name) to the HLR/HSS at step S9. The HSS, responsive to step S9, stores the S-CSCF name for that subscriber and, at step S10, the HSS sends a Cx-Put Resp message to the S-CSCF to acknowledge receipt of the Cx-Put message.

On receipt of the Cx-Put Resp message, the S-CSCF, at step S11, sends Cx-Pull information flow (subscriber identity) to the HSS which, at step S12, downloads the relevant information from the subscriber profile to the S-CSCF.

The S-CSCF, at step S13, stores the information for the indicated user. In addition to the names/addresses information, security information can also be sent for use within the S-CSCF.

The S-CSCF, at step S14, returns the SIP 200 OK information flow (serving network contact information (SNCI)) to the PDG.

The PDG, at step S15, sends information flow SIP 200 OK (SNCI) to the WLAN. The WLAN sends the SIP 200 OK message to the UE, at step S16.

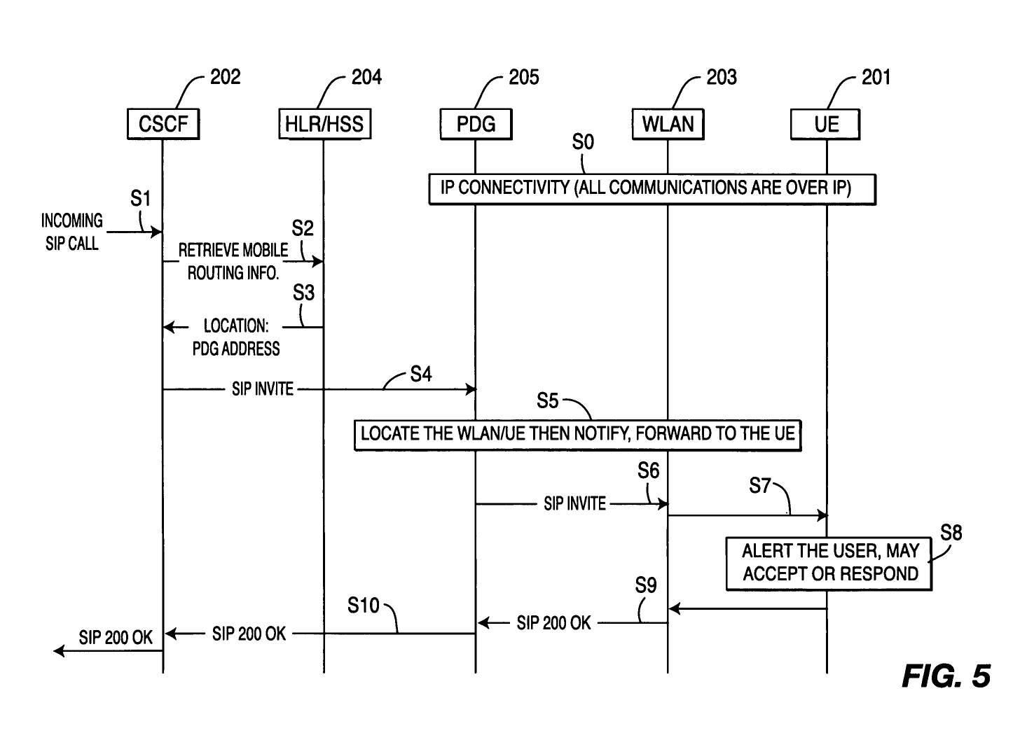

FIG. 5 is a data flow diagram setting forth a procedure for the termination of IMS-based services over a WLAN. WLAN 203 is coupled to UE 201 and also to a PDG 205. Communications between WLAN 203, UE 201, and PDG 205 are over standard IP-based links, (see step S0). Upon receipt of an incoming SIP call, at step S1, CSCF 202 retrieves mobile routing information and, at step S2, sends the routing information to HLR 204. In response to this routing information, HLR 204, at step S3, sends a PDG address to CSCF 202. CSCF 202, at step S4, sends an SIP Invite message to PDG 205 at the PDG address returned by HLR 204. Upon receipt of the SIP Invite message, PDG 205, at step S5, locates the WLAN 203/UE 201 and, at step S6, notifies WLAN 203 by sending WLAN 203 an SIP Invite message. WLAN 203, at step S7, alerts UE 201 as to the existence of an incoming SIP call. If the SIP call is to be accepted at UE 201, UE 201, at step S8, sends an acceptance message to WLAN 203. WLAN 203, at step S9, sends an SIP 200 OK message to PDG 205. PDG 205 responds to the SIP 200 OK message, at step S10, by sending an SIP 200 OK message to CSCF 202. CSCF 202, at step S11, sends the SIP 200 OK message to the cellular network.

FIG. 6 illustrates an exemplary reference point Wi for use as an interface between the MGW, identified as a CSCF 123 and the PDG 119, the details of PDG being as explained above. It is noted that FIG. 3, as explained earlier, illustrates interface Wi for use as an interface between the IMS subsystem (CSCF) and the PDG.

The foregoing describes an exemplary method and architecture for accessing an IP multimedia subsystem (CSCF) over a WLAN. While this invention has been particularly shown and described with reference to preferred embodiments, it will be understood by those skilled in the art that various changes in form and details may be made therein without departing from the scope of the invention described hereinabove.

1. Apparatus for enabling one of a wireless local area network (WLAN) and a wireless wide area network (WWAN) to access an internet protocol multimedia subsystem (IMS), comprising:
a packet data gateway (PDG) coupled between said IMS and one of said WLAN and WWAN for providing IMS services to subscribers operating in said one of said WLAN and said WWAN systems.

2. The apparatus of claim 1 wherein said IMS is a subsystem of a call state control function (CSCF) and said PDG is coupled to said CSCF.

3. The apparatus of claim 1 wherein IMS includes means for routing session initiation protocol (SIP) messages.

4. The apparatus of claim 1 further comprising:
a packet data network (PDN); and
said PDG having means for communicating packet data between said PDN and one of said WLAN and WWAN.

5. The apparatus of claim 1 further comprising:
at least one wireless transmitter receiver unit (WTRU); and
said one of said WLAN and WWAN comprising an access network for sending/receiving SIP messages to/from said WTRU.

6. The apparatus of claim 5 further comprising:
said PDG being part of a first cellular network (FCNW); and
a second packet gateway (SPDG) in a second cellular network (SCNW);
a border gateway (BGW) in said FCNW selectively coupling packet data (PD) from PDGs in said FCNW and SCNW to said access network.

7. The apparatus of claim 1 further comprising:
a media gateway (MGW); and
said PDG having means for coupling media services from said MGW to one of said WLAN and WWAN.

8. The apparatus of claim 2 further comprising:
a gateway general packet radio service support node (GGSN) coupling said CSCF to a cellular network for providing messages between said cellular network and one of said WLAN and WWAN.

9. A method employing a packet data gateway (PDG) for use in providing services to wireless transmit/receive units (WTRUs) communicating with a wireless local area network (WLAN) interworked with a cellular network having an internet protocol multimedia subsystem forming part of a call state control function (CSCF), comprising:
said PDG routing packet data between a packet data network and a WTRU through said WLAN.

10. A method employing a packet data gateway (PDG) for use in providing services to wireless transmit/receive units (WTRUs) communicating with a wireless local area network (WLAN) interworked with a cellular network having an internet protocol multimedia subsystem (IMS) forming part of a call state control function (CSCF), comprising:
said cellular network generating a short message, transfer protocol data unit (TPDU); and
said PDG:
receiving the short message TPDU;
checking the short message TPDU for errors; and
encapsulating and sending the short message TPDU to a targeted one of said WTRUs.

11. The method of claim 10 further comprising said PDG:
receiving a delivery from said WTRU; and
sending confirmation to the cellular network that the short message TPDU was delivered to said targeted WTRU.

12. The method of claim 10 further comprising said PDG:
receiving a delivery failure from said WTRU; and
sending a message to the cellular network that the short message TPDU failed to be delivered to said targeted WTRU.

13. The method of claim 10 wherein the short message is formatted in internet protocol (IP).

14. A method for accessing an internet protocol multimedia subsystem (IMS) over wireless local area networks (WLANs) and/or wireless wide area networks (WWANs) and compatible with standard 3GPP TS 23.234, comprising:
providing a packet data gateway (PDG) between said IMS and one of said WLANs/WWANs to enable 3GPP based IMS access over said one of said WLANs/WWANs.

15. The method of claim 14 wherein said IMS comprises a call state control function (CSCF), said method further comprising:
providing a first packet data interface between said CSCF and said PDG; and
providing a second packet data interface between said one of said WLANs/WWANs and said PDG.

16. The method of claim 14 wherein said IMS comprises a call state control function (CSCF), said method further comprising:
providing a first Wi interface between said CSCF and said PDG; and
providing a second Wi interface between said one of said WLANs/WWANs and said PDG.

17. The method of claim 15 wherein a media gateway (MGW) is provided, said method further comprising providing a third packet data interface between said MGW and said PDG.

18. The method of claim 16 wherein a media gateway (MGW) is provided, said method further comprising providing a third Wi interface between said MGW and said PDG.

19. The method of claim 14 wherein said PDG provides routing information for WLAN/WWAN-3GPP connected users.

20. The method of claim 14 wherein said PDG routes packet data received from and sent to a packet data network (PDN).

21. The method of claim 14 wherein said PDG performs address translation and mapping.

22. The method of claim 14 wherein said PDG performs encapsulation.

23. The method of claim 14 wherein said PDG generates charging information related to data traffic of a user equipment (UE) communicating with said one of said WLANs/WWANs.

24. The method of claim 14 wherein said PDG:
receives a short message transfer protocol data unit (TPDU); and
encapsulates and sends the short message to a targeted user equipment (UE).
